(19) United States
(12) Patent Application Publication
(10) Pub. No.: US 2009/0185476 A1
(43) Pub. Date: Jul. 23, 2009

(54) DURATION-SHORTENED OFDM SYMBOLS

(75) Inventors: Shiau-He TSAI, San Diego, CA (US); Tsao-Tsen CHEN, Alvsjo (SE); Per ERNSTROM, Stockholm (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson, Stockholm (SE)

(21) Appl. No.: 12/354,159

(22) Filed: Jan. 15, 2009

Related U.S. Application Data
(60) Provisional application No. 61/021,499, filed on Jan. 16, 2008.

(51) Int. Cl. H04J 11/00; H04K 1/10; H04B 7/00; H04W 4/00

(52) U.S. Cl. 370/210; 375/260; 370/277; 370/328

(57) ABSTRACT

A communications network comprises a base station (28) and a wireless terminal (30) which communicate a frame (F) of information over an air interface (32). The frame (F) is prepared or processed to accommodate duration-shortened symbols. The preparation or processing the frame occurs in a manner whereby: (1) at least some of OFDM symbols of the frame have a symbol duration T_{base} in accordance with a base frequency 1/T_{base} of subcarriers employed for the frame; and (2) at least one duration-shortened OFDM symbol of the frame has a symbol duration T_{base}/N, wherein N is an integer greater than one and wherein a subset of subcarriers are utilized for the select OFDM symbol, the subset of subcarriers being frequencies which are integer multiples of a N^{th} harmonic of the base frequency 1/T_{base}. In an example embodiment, the duration-shortened symbol is inserted in a portion of the frame corresponding to a transition gap for at least one version of the frame.

This application claims the priority and benefit of U.S. Provisional Patent Application 61/021,499 filed Jan. 16, 2008, entitled “FRACTIONAL OFDM SYMBOL USAGE DURING TDD TRANSITION GAPS”, which is incorporated herein by reference in its entirety. This application is related to one or more of the following (all of which are incorporated herein by reference in their entirety): U.S. patent application Ser. No. 12/138,000, entitled “TELECOMMUNICATIONS FRAME STRUCTURE ACCOMMODATING DIFFERING FORMATS”; U.S. patent application Ser. No. 12/259,068, entitled “BACKWARDS COMPATIBLE IMPLEMENTATIONS OF SC-FDMA UPLINK IN WiMAX”; U.S. patent application Ser. No. 12/333,147, entitled “RANGING PROCEDURE IDENTIFICATION OF ENHANCED WIRELESS TERMINAL”.

### BACKGROUND

This invention pertains to telecommunications, and particularly to utilization of otherwise unused resource or space in a transmission frame or the like.

In a typical cellular radio system, wireless terminals (also known as mobile terminals, mobile stations, and mobile user equipment units (UEs)) communicate via base stations of a radio access network (RAN) to one or more core networks. The wireless terminals (WT) can be mobile stations such as mobile telephones (“cellular” telephones) and laptops with mobile termination, and thus can be, for example, portable, pocket, hand-held, computer-included, or car-mounted mobile devices which communicate voice and/or data with radio access network. The base station, e.g., a radio base station (RBS), is in some networks also called “NodeB” or “B node”. The base stations communicate over the air interface (e.g., radio frequencies) with the wireless terminals which are within range of the base stations.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UTRAN is essentially a radio access network providing wideband code division multiple access for user equipment units (UEs). The radio access network in a UMTS network covers a geographical area which is divided into cells, each cell being served by a base station. Base stations may be connected to other elements in a UMTS type network such as a radio network controller (RNC). The Third Generation Partnership Project (3GPP or “3G”) has undertaken to evolve further the predecessor technologies, e.g., GSM-based and/or second generation (“2G”) radio access network technologies.

The IEEE 802.16 Working Group on Broadband Wireless Access Standards develops formal specifications for the global deployment of broadband Wireless Metropolitan Area Networks. Although the 802.16 family of standards is officially called WirelessMAN, it has been dubbed WiMAX” (from “Worldwide Interoperability for Microwave Access”) by an industry group called the WiMAX Forum. For further information regarding WiMAX generally, see, e.g., IEEE Standard 802.16e-2005 and IEEE Standard 802.16-2004/Cor1-2005 (Amendment and Corrigendum to IEEE Standard 802.16-2004), “IEEE Standard for local and metropolitan area networks, Part 16: Air Interface for Fixed and Mobile Broadband Wireless Access Systems, Amendment 2: Physical and Medium Access Control Layers for Combined Fixed and Mobile Operation in License Bands,” Feb. 28, 2006, all of which are incorporated herein by reference in their entireties.

IEEE 802.16e-2005 (formerly known as IEEE 802.16e) is in the lineage of the specification family and addresses mobility by implementing, e.g., a number of enhancements including better support for Quality of Service and the use of Scalable OFDMA. In general, the 802.16 standards essentially standardize two aspects of the air interface—the physical layer (PHY) and the Media Access Control layer (MAC).

Concerning the physical layer, IEEE 802.16e uses scalable OFDMA to carry data, supporting channel bandwidths of between 1.25 MHz and 20 MHz, with up to 2048 sub-carriers. IEEE 802.16e supports adaptive modulation and coding, so that in conditions of good signal, a highly efficient 64 QAM coding scheme is used, whereas where the signal is poorer, a more robust BPSK coding mechanism is used. In intermediate conditions, 16 QAM and QPSK can also be employed. Other physical layer features include support for Multiple-in Multiple-out (MIMO) antennas in order to provide good performance in NLOS (Non-line-of-sight) environments and Hybrid automatic repeat request (HARQ) for good error correction performance.

In terms of Media Access Control layer (MAC), the IEEE 802.16e encompasses a number of convergence sublayers which describe how wireline technologies such as Ethernet, ATM and IP are encapsulated on the air interface, and how data is classified, etc. It also describes how secure communications are delivered, by using secure key exchange during authentication, and encryption during data transfer. Further features of the MAC layer include power saving mechanisms (using Sleep Mode and Idle Mode) and handover mechanisms.

The frame structure for IEEE standard 802.16e is shown in FIG. 1. The frame length for IEEE standard 802.16e is 5 ms in one example mode, and uses time division duplex (TDD). The preamble is used by mobile stations to synchronize to the downlink (DL), and the DL-MAP and UL-MAP messages that occur just following the preamble give allocation information to the mobile stations on the downlink and the uplink. Examples of downlink and uplink allocations are shown in FIG. 1.

As mentioned above, presently WiMAX utilizes orthogonal frequency division multiple access (OFDMA). Like OFDM, OFDMA transmits a data stream by dividing the data stream over several narrow band sub-carriers (e.g. 512, 1024 or even more depending on the overall available bandwidth [e.g., 5, 10, 20 MHz] of the channel) which are transmitted simultaneously. The sub-carriers are divided into groups of sub-carriers, each group also being referred to as a sub-channel. The sub-carriers that form a sub-channel need not be adjacent. As many bits are transported in parallel, the transmission speed on each sub carrier can be much lower than the overall resulting data rate. This is important in a practical radio environment in order to minimize effect of multipath fading created by slightly different arrival times of the signal from different directions.

In a time-division duplexing (TDD) system such as IEEE standard 802.16e, the downlink (DL) and the uplink (UL) transmissions occupy the same frequency band. To ensure proper transition between the receiver and the transmitter that use the same frequency band, the TDD DL and UL typically alternate in time with non-negligible transition gaps between them in a manner such as that shown in FIG. 1. The transition gaps as shown in FIG. 1 are named with respect to the base station (BS) operation. Accordingly, the gap that allows the base station (BS) to switch from transmitting to receiving is called the transmit-to-receive gap (TTG); the gap for base station (BS) to switch from receiving to transmitting is called the receive-to-transmit gap (RTG).

The transition gaps (e.g., TTG and RTG) need to be large enough such that:
1. The receiver and the transmitter units have a reasonable amount of time for the aggregate DL inter-cell interference to fade before the UL transmission starts, and vice versa.
2. The TDD transceiver has sufficient time to switch between transmitting and receiving modes.

In current IEEE 802.16 TDD systems, only one TTG and one RTG exist in a frame. However, as the IEEE 802.16 specification evolves, there are proposals to include shorter DL and UL subframes to reduce the HARQ delays for higher throughput and increase CQI reporting rate for higher mobility. An example of such is IEEE standard 802.16m, which is intended to be an evolution of IEEE standard 802.16e with the aim of higher data rates and lower latency.

An example frame structure for the IEEE standard 802.16m is illustrated in FIG. 2 and discussed in U.S. patent application Ser. No. 12/138,000, entitled “TELECOMMUNICATIONS FRAME STRUCTURE ACCOMMODATING DIFFERING FORMATS”, filed Jun. 12, 2008, which is incorporated herein by reference in its entirety. FIG. 2 illustrates its frame structure has having two downlink bursts [DL burst 1 (“DL1”) and DL burst 2 (“DL2”)] as well as two uplink bursts [UL burst 1 (“UL 1”) and UL burst 2 (“UL2”)]. The order of the bursts in the frame is DL 1, UL1, DL2, and UL2. The frame of FIG. 2 has four transition gaps: TTG1 between DL1 and UL1; RTG1 between UL1 and DL2; TTG2 between DL2 and UL2; and RTG2 between UL2 and the next downlink burst (in the next frame).

It should be noted that UL1 can also be used for relay stations. In that case, the subordinate mobile station (MS) of that relay station will still treat UL1 as part of its legacy DL and the symbol timing should remain the same as DL1. In this case, there is an extra constraint on the end point of TTG1. The relay station, although treated as a mobile station from the base station point of view, is transmitting during UL1 and viewed by its subordinate MS as part of the DL. The signaling and data formats during the UL1 period is specified, e.g., in IEEE 802.16j.

Some wireless terminals operating in the WiMAX system may be older terminals (e.g., “legacy” terminals) which, although compatible with upgraded or subsequent versions of WiMAX, are not able to take advantage of enhanced capabilities preferred by WiMAX. For example, in view of the compatibility of WiMAX IEEE standard 802.16m back to IEEE standard 802.16e, a 802.16e-version wireless terminal can operate in a 802.16m network, but (unlike a 802.16m-version or “enhanced” wireless terminal) cannot take full advantages of the enhanced capabilities of the 802.16m network. With the advent of 802.16m, the 802.16m-version wireless terminals are expected to have significantly more capabilities than legacy wireless terminals. For example, they may be able to receive more complex MIMO signals, be capable of receiving a different modulation, or be capable of receiving the downlink (DL) signal in a portion of the time-frequency grid where legacy wireless terminals cannot receive the signal. They may also be able to transmit in a different portion of the time frequency grid, and use a more efficient transmit signal. If the base station does not know that the terminal is capable of these advanced capabilities, it has to allocate resources to the terminal only assuming legacy capabilities for the terminal.

Returning now to the topic of gaps, there can be gaps in both the time division duplex (TDD) frame and the frequency division duplex (FDD) frame. The FDD gap comes from the fact that the IEEE Standard 802.16e frame duration, an integer multiple of 2.5 ms, is not divisible by possible values of OFDM symbol duration. For example, in the mobile WiMAX profile, the OFDM symbol duration is approximately 102.86 μs, which leaves an un-used remainder of approximately 62.72 μs. This is because the orthogonal frequency division multiplexing (OFDM) symbol length is determined by the bandwidth and the selected cyclic prefix length.

Concerning the TDD frame gap, one example occurs at 5 MHz bandwidth and ⅛ cyclic prefix, with one OFDM symbol being around 102 μs. With a transmit transition gap (TTG) of 106 μs and an receive transition gap (RTG) of 60 μs, approximately 40 μs is left un-used, although the percentage of radio resource wasted is extremely small. Table 1 shows transmit transition gap (TTG) and receive transition gap (RTG) values in the current Worldwide Interoperability for Microwave Access (WiMAX) system profile for the 802.16e system. Table 1 show various parameters, including bandwidth (BW), physical slot (PS), and sampling frequency (“fs”).

TABLE 1
RTG and TTG in WiMAX System Profile
Maximum TTG and RTG Switching Time per Channel Band-Width

| BW | fs | PS | RTG | RTG | TTG | TTG | Ts, Symbol |
|---|---|---|---|---|---|---|---|
| (MHz) | (MHz) | (μS) | (PSs) | (μS) | (PSs) | (μs) | time (μs) |
| 3.5 | 4 | 1 | 60 | 60 | 188 | 188 | 144 |
| 5 | 5.6 | 0.714286 | 84 | 60 | 148 | 105.7142857 | 102, 9 |
| 7 | 8 | 0.5 | 120 | 60 | 376 | 188 | 144 |
| 8.75 | 10 | 0.4 | 186 | 74.4 | 218 | 87.2 | 115, 2 |
| 10 | 11.2 | 0.357143 | 168 | 60 | 296 | 105.7142857 | 102, 9 |

The problems with existing solutions mainly come in the TDD case, where the transmission gaps are not negligible. If more DL/UL subframe switching points are introduced in a manner such as that illustrated in FIG. 2, for example, the system performance will degrade. Such degradation could occur since more time resources are wasted for transition gaps and are not used for data transmission. The problem gets worse if the new shorter DL/UL subframes need to be time aligned with the legacy DL OFDM symbol timing.

### SUMMARY

In one of its aspects the technology disclosed herein concerns a method of operating a communications network comprising a base station and a wireless terminal which communicate a frame of information over an air interface with the base station.

The method comprises preparing or processing the frame to accommodate duration-shortened symbols, and transmitting the frame over the interface. The preparing or processing the frame occurs in a manner whereby: (1) at least some of OFDM symbols of the frame have a symbol duration T_{base} in accordance with a base frequency 1/T_{base} Of subcarriers employed for the frame; and (2) at least one duration-shortened OFDM symbol of the frame has a symbol duration T_{base}/N, wherein N is an integer greater than one and wherein a subset of subcarriers are utilized for the select OFDM symbol, the subset of subcarriers being frequencies which are integer multiples of a N^{th} harmonic of the base frequency 1/T_{base}. In an example embodiment, the method further comprises inserting the duration-shortened symbol in a portion of the frame corresponding to a transition gap for at least one version of the frame.

In another of its aspects the technology disclosed herein concerns a base station comprising a transceiver and a diverse symbol duration frame handler. The transceiver is configured to communicate a frame over an air interface with a wireless terminal. The frame handler is arranged to prepare or process the frame in a manner whereby: (1) at least some of OFDM symbols of the frame have a symbol duration T_{base} in accordance with a base frequency 1/T_{base} of subcarriers employed for the frame; and (2) at least one duration-shortened OFDM symbol of the frame has a symbol duration T_{base}/N, wherein N is an integer greater than one and wherein a subset of subcarriers are utilized for the selected OFDM symbol, the subset of subcarriers being frequencies which are integer multiples of a N^{th} harmonic of the base frequency 1/T_{base}. In example implementation, the frame handler is further arranged to insert the duration-shortened symbol in a portion of the frame corresponding to a transition gap for at least one version of the frame.

In another of its aspects the technology disclosed herein concerns a wireless terminal. The wireless terminal comprises a transceiver and a diverse symbol duration frame handler. The transceiver is configured to receive a frame over an air interface from a base station. The frame handler is arranged to demodulate the frame in a manner whereby: (1) at least some of OFDM symbols of the frame have a symbol duration T_{base} in accordance with a base frequency 1/T_{base} of subcarriers employed for the frame; and (2) at least one duration-shortened OFDM symbol of the frame has a symbol duration T_{base}/N, wherein N is an integer greater than one and wherein a subset of subcarriers are utilized for the selected OFDM symbol, the subset of subcarriers being frequencies which are integer multiples of a N^{th} harmonic of the base frequency 1/T_{base}. In an example embodiment, the frame handler is further arranged to obtain the duration-shortened symbol from a portion of the frame corresponding to a transition gap for at least one version of the frame.

Thus, shortened duration symbols, e.g., fractional Orthogonal Frequency Division Multiplexing (OFDM) symbols, can be used to transmit data packets. Advantageously, in an example implementation the use of the duration-shortened symbols can be used with the same fast Fourier transform (FFT) operation(s) that are employed for normal duration symbols. The orthogonality between subcarriers of a specific subset over a smaller time support is utilized. The fractional OFDM symbol usage can be used to fill-up the unused space left by the insertion of new TTG/RTG.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of TDD frame structure according to IEEE 802.16.

FIG. 2 is a diagrammatic view of a frame structure having extra uplink and downlink subframe switching for delay improvement.

FIG. 3 is a schematic view of an example telecommunications system which serves as an example suitable environment for implementation and utilization of a frame comprising diverse duration symbols.

FIG. 4A is a diagrammatic view of a first example configuration of a frame having symbol duration diversity.

FIG. 4B is a diagrammatic view of a second example configuration of a frame having symbol duration diversity.

FIG. 5 is a graphical view showing a relationship of useful OFDM symbol time, base frequency, and harmonics.

FIG. 6 is a graphical view showing an even integer multiple of base frequency for fractional symbol time OFDM signal.

FIG. 7 is a graphical view showing an integer multiple of 3× base frequency for fractional symbol time OFDM signal.

FIG. 8 is a schematic view of an orthogonal frequency division multiplexing (OFDM) system according to an example embodiment, including an OFDM transmitter and an OFDM receiver.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

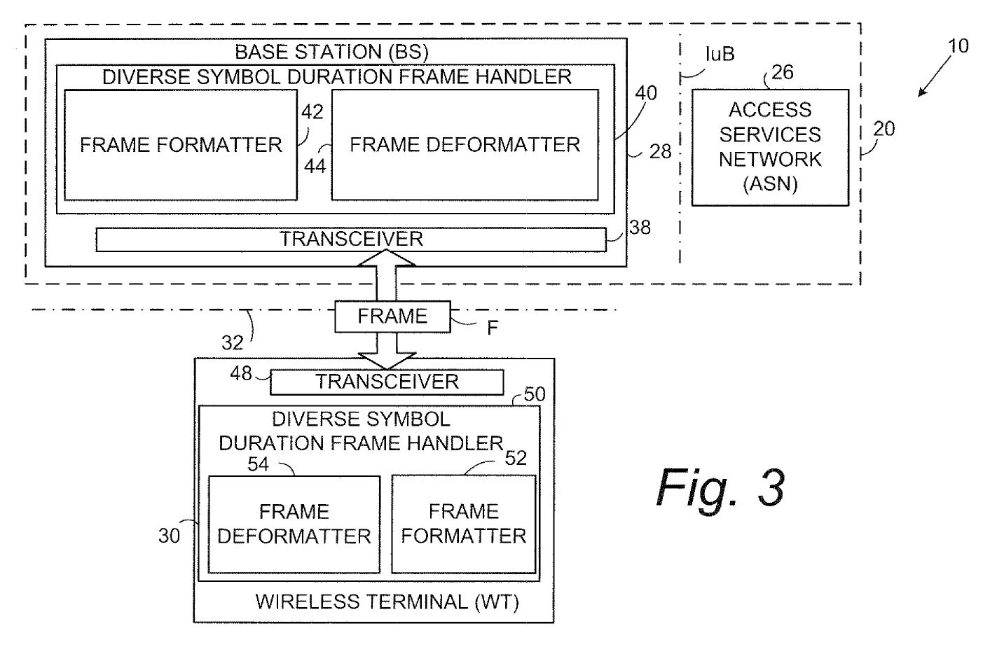

The technology described herein is advantageously illustrated in the example, non-limiting, context of a telecommunications system 10 such as that schematically depicted in FIG. 3. The example telecommunications system 10 of FIG. 3 shows a radio access network 20 which can be connected to one or more external (e.g., core) networks. The external networks may comprise, for example, connection-oriented networks such as the Public Switched Telephone Network (PSTN) and/or the Integrated Services Digital Network (ISDN), and/or connectionless external core network such as (for example) the Internet. One or more of the external networks have unillustrated serving nodes such as, e.g., an Access Services Network (ASN) Gateway node working in conjunction with one or more Core Services Network (CSN) components.

The radio access network (RAN) 20 includes one or more Access Services Network (ASN) nodes 26 and one or more radio base stations (RBS) 28. For sake of simplicity, the radio access network (RAN) 20 of FIG. 3 is shown with only one ASN node 26 and one base station node (BS) 28. Typically each ASN 26 is connected to one or more base stations (BS) 28, but the number of nodes is not necessarily germane to the present technology. Those skilled in the art will also appreciate that a base station is sometimes also referred to in the art as a radio base station, a node B, eNodeB 28, or B-node (all of which are used interchangeably herein).

As shown in FIG. 3, a wireless terminal (WT) 30 communicates with one or more cells or one or more base stations (BS) 28 over a radio or air interface 32. In differing implementations, the wireless terminal (WT) 30 can be known by different names, such as mobile terminal, mobile station or MS, user equipment unit (UE), handset, or remote unit, for example. Each mobile terminal (MT) may be any of myriad devices or appliances, such as mobile phones, mobile laptops, pagers, personal digital assistants or other comparable mobile devices, SIP phones, stationary computers and laptops equipped with a real-time application, such as Microsoft netmeeting, Push-to-talk client etc.

As shown in FIG. 3, in an example embodiment base station 28 comprises base station transceiver 38 and base station frame handler 40. Transceiver 38 is involved in communicating frame(s) of information (illustrated as frame F in FIG. 3) over air interface 32 with wireless terminals participating in a connection with base station 28. The transceiver 38 includes both a transmitter(s) for transmitting downlink (DL) portions or bursts of frames, as well as a receiver(s) for receiving uplink (UL) portions or bursts of frames. As used herein, “transceiver” can include one or more transceivers and further encompasses radio transmission and/or reception equipment suitable for transmitting/receiving a data stream or the like in the form of plural sub-carriers or subchannels (such as in OFDMA and SC-FDMA, for non-limiting examples), including plural antennas when appropriate.

The base station frame handler 40 is involved in processing frames (such as frame F) which are communicated between base station 28 and wireless terminal (WT) 30. More detailed aspects of structure and composition of the frames F are discussed subsequently. Since in this technology the frame(s) have both downlink (DL) portions or bursts and uplink (UL) portions or bursts, the frame handler 40 in turn comprises frame formatter 42 (which facilitates preparation of the downlink (DL) bursts prior to transmission by transceiver 38) and base station frame deformatter 44 (which facilitates processing of the uplink (UL) bursts as received by transceiver 38 from wireless terminal (WT) 30). In an example embodiment, frame handler 40, as well as its frame formatter 42 and deformatter 44, can be realized by one or more processors or controllers as those terms are herein expansively explained.

For sake of simplicity, FIG. 3 does not show other well-known functionalities and/or units of base station 28, such as (by way of non-limiting example) interfaces to other nodes of the radio access network (RAN); queues through which data is collected or assembled preparatory to inclusion in the downlink (DL) bursts configured by base station frame formatter 42; generators or processors for preparing signaling information for inclusion in the downlink (DL) bursts configured by frame formatter 42; queues into which data obtained from uplink (UL) bursts are stored after processed by base station deformatter 44; units of base station 28 which utilize the data and/or signaling included in uplink (UL) bursts; or node processors or the like which supervise or coordinate the constituent units or functionalities of base station 28.

Wireless terminal (WT) 30 comprises wireless terminal frame handler 50. Frame handler 50 comprises wireless terminal frame formatter 52 and wireless terminal frame deformatter 54. Wireless terminal frame formatter 52 serves, e.g., to prepare uplink (UL) bursts of the frames prior to transmission to base station 28 by wireless terminal transceiver 48. Wireless terminal deformatter 54 serves, e.g., to process downlink (DL) bursts received by transceiver 48 over air interface 32 from base station 28. FIG. 3 shows wireless terminal (WT) 30 communicating/exchanging a frame F with base station 28 over air interface 32.

Returning to base station 28, base station frame handler 40 is configured to be capable of generating and processing a frame so that at least one symbol of the frame has a shortened duration relative to the preponderance of the symbols of the frame (the preponderance of the symbols of the frame having a nominal or standard duration). Accordingly, base station frame handler 40 is also known as a diverse symbol duration frame handler. A symbol of nominal or standard duration can be, for example, a symbol having a duration described or prescribed or encompassed by an existing IEEE 802.16 standards document.

A symbol of nominal or standard duration can thus have a symbol duration T_{base} in accordance with a base frequency 1/T_{base} of subcarriers employed for the frame. On the other hand, an example of a shortened-duration symbol (also known as a “fractional symbol”) is a symbol which has a symbol duration T_{base}/N (wherein N is an integer greater than one).

Thus, the base station frame handler 40, i.e., the diverse symbol duration frame handler 40, is configured to prepare or process the frame F in a manner whereby (1) at least some of OFDM symbols of the frame have a symbol duration T_{base} in accordance with a base frequency 1/T_{base} of subcarriers employed for the frame; and (2) at least one shortened-duration OFDM symbol of the frame has a symbol duration T_{base}/N, wherein N is an integer greater than one and wherein a subset of subcarriers are utilized for the shortened-duration OFDM symbol, the subset of subcarriers being frequencies which are integer multiples of a N^{th} harmonic of the base frequency 1/T_{base}. Preferably, a preponderance (e.g., more than half) of the OFDM symbols of the frame have a symbol duration T_{base} in accordance with a base frequency 1/T_{base} of subcarriers employed for the frame.

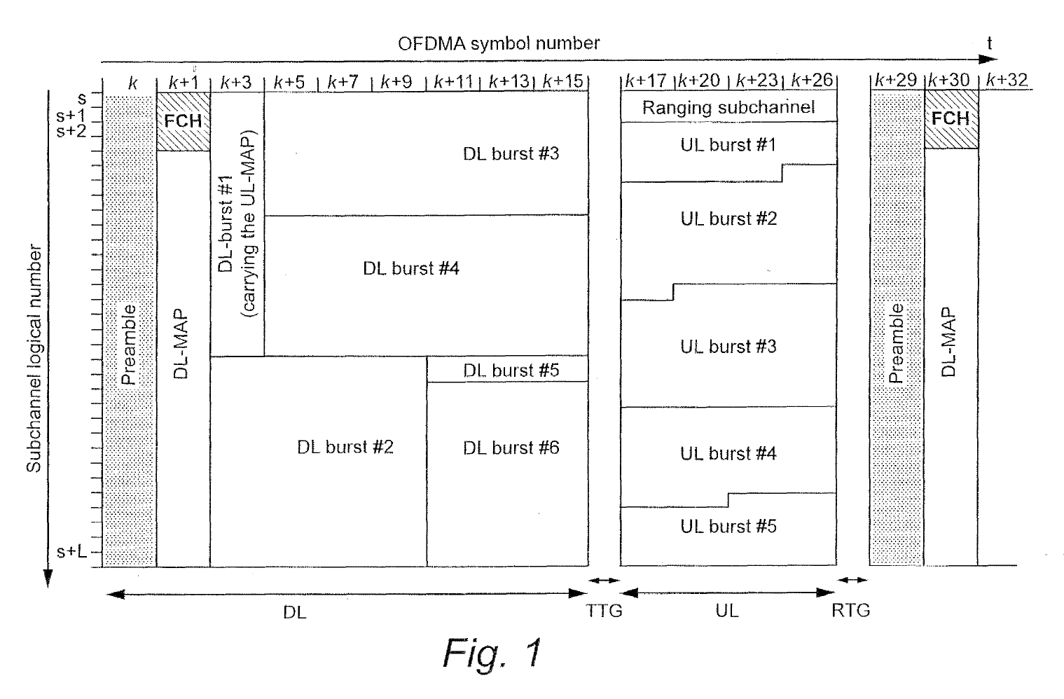

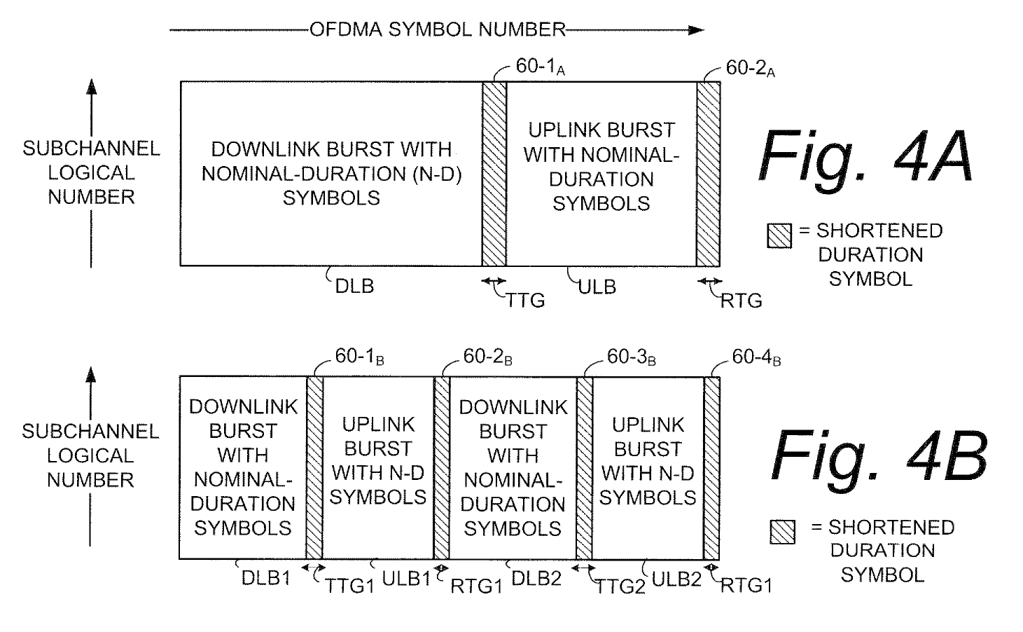

FIG. 4A illustrates an example format of a frame having symbol duration diversity. The frame of FIG. 4A resembles the IEEE standard 802.16e frame of FIG. 1 in having a downlink burst (DLB) and a uplink burst (ULB). Plural symbols are included in each of downlink burst (DLB) and uplink burst (ULB). However, the frame of FIG. 4A differs from the frame of FIG. 1 in comprising two areas which host or accommodate shortened-duration symbols, such as shortened-duration symbol 60-1_{A} and shortened-duration symbol 60-2_{A}. The shortened-duration symbol 60-1_{A} resides in or occupies at least a portion of the frame which otherwise would have been the transmit transition gap (TTG) of the frame of FIG. 1. Similarly, shortened-duration symbol 60-2_{A} resides in or occupies at least a portion of the frame which otherwise would have been the receive transition gap (RTG) of the frame of FIG. 1.

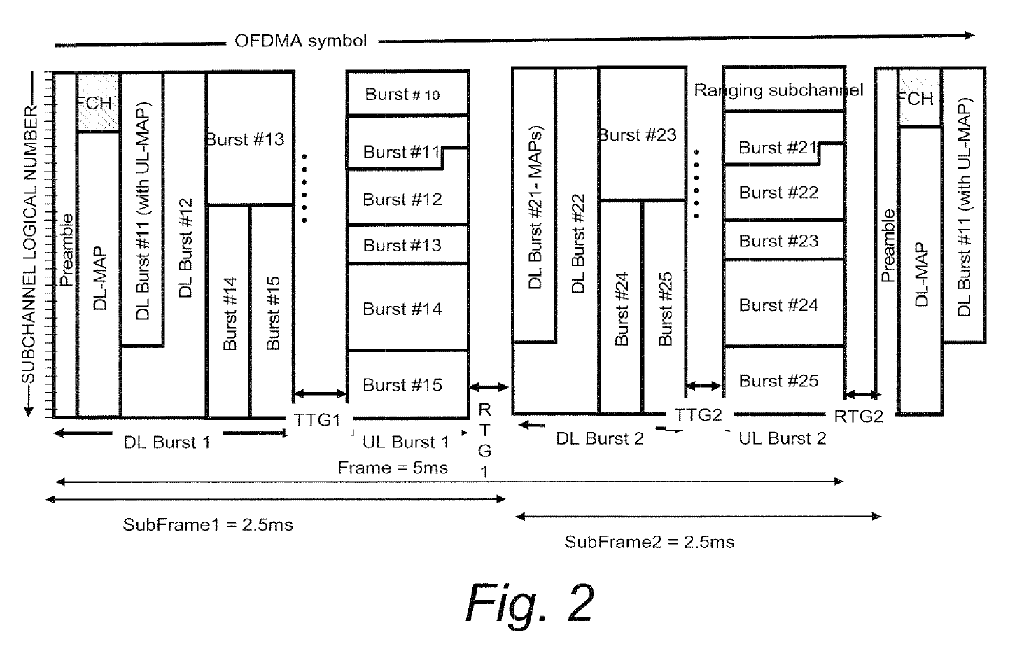

FIG. 4B illustrates another (e.g., an alternative) example format of a frame having symbol duration diversity. The frame of FIG. 4B resembles the frame of FIG. 2 in having two downlink bursts (DLB1 and DLB2) and two uplink bursts (ULB1 and ULB2). Plural symbols are included in each of the two downlink bursts and each of the two uplink bursts. However, the frame of FIG. 4B differs from the frame of FIG. 2 in comprising four areas which host or accommodate shortened-duration symbols, such as shortened-duration symbols 60-1_{B} through and including 60-4_{B}. The shortened-duration symbol 60-1_{B} resides in or occupies at least a portion of the frame which otherwise would have been the transmit transition gap (TTG1) of the frame of FIG. 2. The shortened-duration symbol 60-3_{B} resides in or occupies at least a portion of the frame which otherwise would have been the transmit transition gap (TTG2) of the frame of FIG. 2. Shortened-duration symbol 60-2_{B} resides in or occupies at least a portion of the frame which otherwise would have been the receive transition gap (RTG1) of the frame of FIG. 2. Shortened-duration symbol 60-4_{B} resides in or occupies at least a portion of the frame which otherwise would have been the receive transition gap (RTG2) of the frame of FIG. 2.

The shortened-duration symbols (also known as “fractional symbols” or “fractional OFDM symbols”) can be used to transmit data packets with the same fast Fourier transform (FFT) operation as is otherwise used for transmission of the remainder of the frame. Moreover, according to the technology disclosed herein, orthogonality between subcarriers of a specific subset over a smaller time support is utilized. As explained in the two examples illustrated in FIG. 4A and FIG. 4B, the fractional OFDM symbol usage can be used to fill-up the unused space of a transmit transition gap (TTG) and/or a receive transition gap (RTG), and particularly the unused space left by the insertion of any new transmit transition gap (TTG) or receive transition gap (RTG) as occurs in the situation of FIG. 2, for example.

The duration of an OFDM signal, when inserted in the transition gaps, can be reduced by only including a subset of evenly spaced subcarriers. This is illustrated and understood with reference to FIG. 5 through FIG. 7. In FIG. 5, the subcarriers of an OFDMA symbol are illustrated for frequencies 1/T_{base}=f_{base}, 2f_{base}, etc., up to 6f_{base}, where T_{base} is the useful OFDM symbol duration and its reciprocal is called the base frequency.

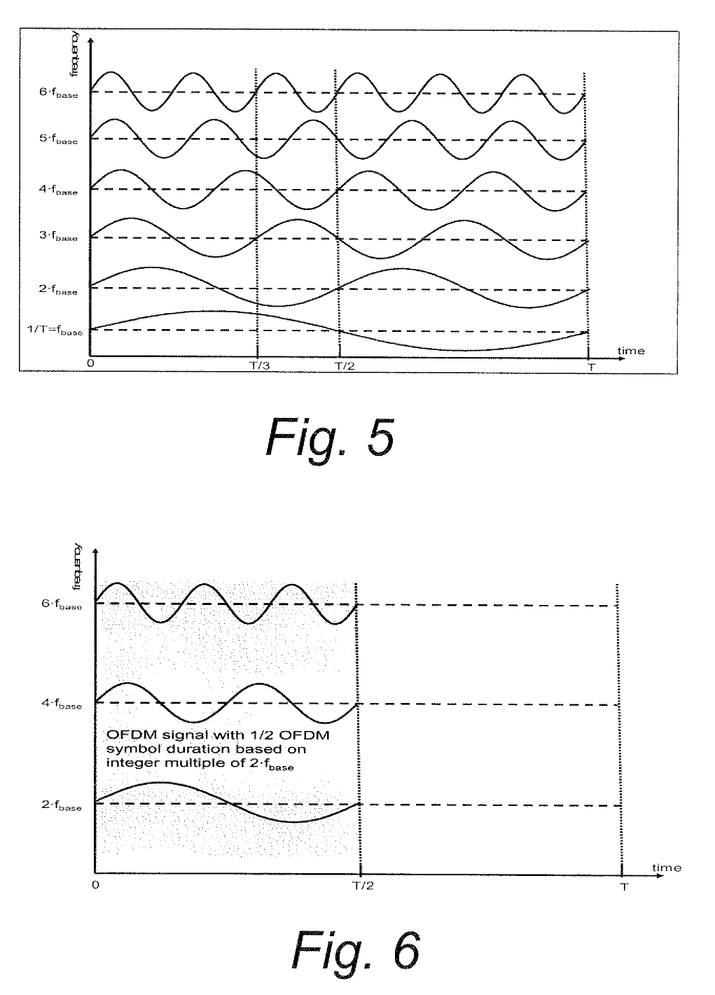

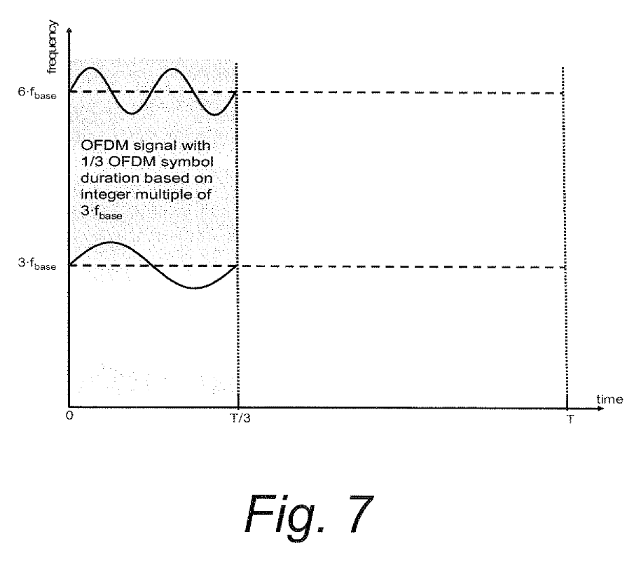

As can be seen, the period for the frequency 2f_{base} is half of that for f_{base}; the period for the frequency 3f_{base} is one third of that for f_{base}, etc. Hence, using, for example, every other subcarrier starting with 2f_{base} will reduce the OFDMA symbol duration to half, while the orthogonality is still maintained over the time support of a ½ OFDM symbol duration. This is illustrated in FIG. 6, which shows the ½ OFDM symbol duration based on integer multiples of 2f_{base}. Following the same principle, using only every third subcarrier 3f_{base}, 6f_{base}, 9f_{base} etc., will reduce the OFDM symbol duration to one third while still maintaining orthogonality. This is illustrated in FIG. 7, which shows the OFDM signal with ⅓ OFDM symbol duration based on integer multiples of 3f_{base}.

Thus, as a general rule, using subcarriers whose frequencies are integer multiples of the Nth harmonic of the base frequency, 1/T_{base}, the symbol duration can be effectively shortened to 1/N of the useful OFDM symbol duration, i.e., T_{base}/N.

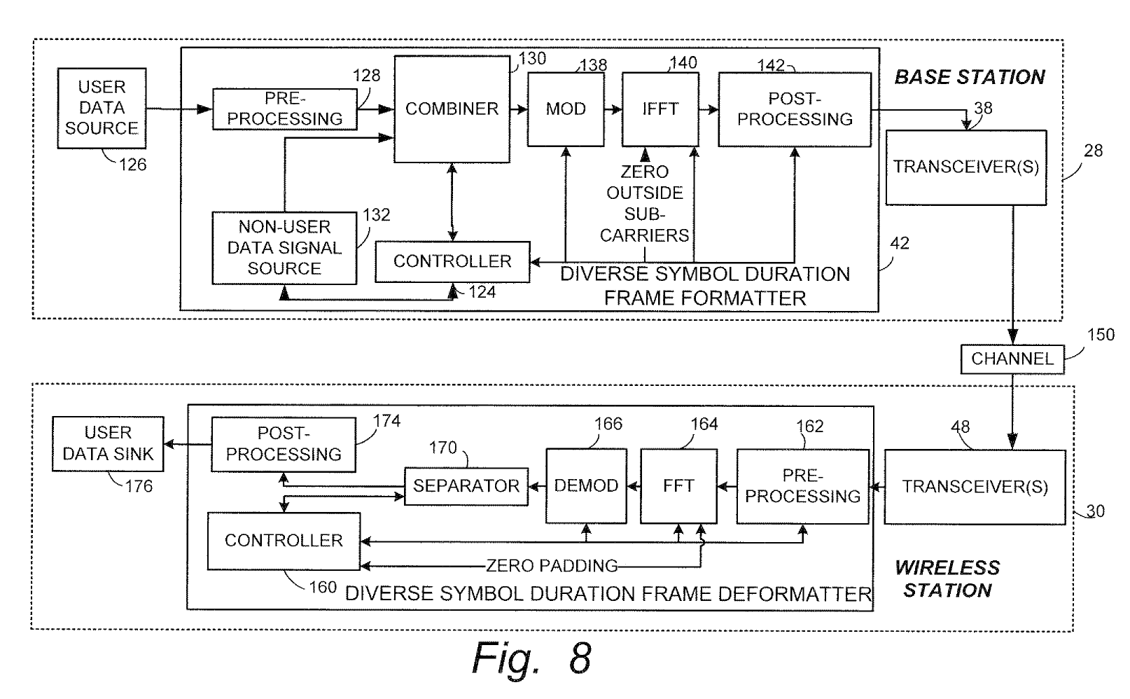

FIG. 8 shows in more detail a non-limiting implementation of both portions of an example base station 28 and portions of an example wireless terminal (WT) 30. FIG. 8 particularly shows, e.g., more details regarding frame formatter 42 of base station frame handler 40 and more details of wireless terminal frame deformatter 54 of wireless terminal (WT) 30. Since the frame formatter 42 and wireless terminal frame deformatter 54 facilitate symbol duration diversity, they are also respectively known as diverse symbol duration frame formatter 42 and diverse symbol duration frame deformatter 54.

The frame formatter 42 of FIG. 8 is shown as operating under control of a controller 124. In fact the controller 124 is illustrated as being connected to various example constituent units of the frame formatter 42. The frame formatter 42 is further shown in FIG. 8 as receiving user data from a user data source 126. Optionally, and depending on the particular implementation, frame formatter 42 of base station frame handler 40 comprises a pre-processing section 128 which can manipulate the user data obtained from user data source 126 by performing such optional functions as serial-to-parallel conversion and channel coding and interleaving. The frame formatter 42 of base station frame handler 40 also comprises a combiner 130 which combines the user data (optionally coded and/or interleaved) with non-user data signals such as control signals, synchronization signals, framing signals, and pilot signals. In FIG. 8, such control signals, synchronization signals, framing signals, and pilot signals are shown as being applied or received from a non-user data signal source 132. The combiner 130, which can be a multiplexer or function as a multiplexer, generates a bit stream by controlled introduction of the non-user data signals into the stream of user data. Control of introduction of the non-user data signals, including pilot signals, is achieved by controller 124. The bit stream output by combiner 130 is modulated by modulator 138 onto a series of sub-carriers. As understood by those skilled in the art, the modulation performed by modulator 138 essentially maps groups of bits to a series of constellation points, represented as complex numbers. A parallel-to-serial conversion may be performed on the complex numbers output by modulator 138 prior to application to an Inverse Fast Fourier Transform (IFFT) unit 140. The Inverse Fast Fourier Transform (IFFT) unit 140 transforms the modulated carriers into a sequence of time domain samples.

The sequence of time domain samples output by Inverse Fast Fourier Transform (IFFT) unit 140 may undergo more processing functions by an optional post-processor 142. Such post-processing functions can include one or more of digital to analog amplification, low pass filtering, up conversion, cyclic extension, windowing, peak control, all of which are understood by the person skilled in the art.

The resultant OFDM waveform is applied to base station transceiver(s) 38. Transceiver(s) 38 comprise radio frequency (RF) circuitry] and plural channel transmission elements. The channel transmission elements can be an antenna or antenna system, for example, applies the OFDM waveform (I, Q output or digital IF signals) to a channel such as channel 150 over radio interface 32.

The example, non-limiting embodiment of wireless terminal 30 shown in FIG. 8 comprises the previously mentioned wireless terminal transceiver 48 and the wireless terminal frame deformatter 54 of wireless terminal frame handler 50. The wireless terminal transceiver 48 comprises a channel reception element which can be an antenna or antenna system, as well as low pass filtering, and analog to digital conversion. The OFDM waveform (I, Q input or digital IF signals) as received by the channel reception element of wireless terminal transceiver 48 is applied to wireless terminal frame deformatter 54 which operates under control of controller 160. In particular the OFDM waveform is applied to an optional pre-processing section 162. The pre-processing section 162 removes carrier offset caused by transmit and receiver local oscillator differences and selects an appropriate sequence of samples to apply to Fast Fourier Transform (FFT) unit 164. The Fast Fourier Transform (FFT) unit 164 converts the time domain waveform to the frequency domain, after which an optional serial to parallel conversion may be performed. With the correct timing instant, the individual sub-carriers are demodulated by demodulator 166. The output of demodulator 166 is applied to separator 170. The separator 170 sorts user data signals from non-user data signals, and may take the form of a demultiplexer or the like. Whatever form it takes, separator 170 is governed by controller 160. The controller 160 is configured to detect non-user data signals such as pilot signals, for example, and to control gating or routing of signals out of separator 170 in accordance with its determination.

User data signals gated out of separator 170 can be applied to an optional post-processing section 174. The post-processing section 174 can perform such functions as channel decoding, de-interleaving, and parallel-to-serial conversion, as appropriate. The user data thusly obtained is applied to a user data sink 176, which can be a voice, text, or other type of application, for example. As previously indicated, the non-user data signals in the demodulated data stream are detected and used by controller 160. Among the non-user data signals are pilot signals.

In some implementations it is possible to provide diverse symbol duration into a standard unit such as an IEEE 802.16e-2005-compatible unit or an IEEE standard 802.16m-compatible unit without having to replace hardware or incorporate new hardware. That is, no new hardware need be required to either send or detect this type of fractional symbol duration OFDM signal. The number of subcarriers available for data modulation is diminished, which is essentially the only loss. With a 1/N fractional use of the OFDM symbol, only 1/N of the subcarriers can be used for data modulation.

As an example of same hardware usage, on the transmitter side, e.g., at base station 28, the same IFFT 140 can be used for both normal duration symbols and shortened duration symbols. For the shortened duration symbols, the subcarriers outside of the set of integer multiples of the N-th harmonics are set to zero, and an FFT of the same size (N_{FFT}) is applied as a normal OFDM symbol. Accordingly, FIG. 8 shows controller 124 directing the IFFT 140 to “set outside subcarriers to zero” or “zero outside subcarrier” for shortened duration symbols. Further, before D/A conversion, only the first 1/N of the N_{FFT} samples is converted from digital to analogue waveform for RF transmission and the remaining (N−1)/N samples are set to zeros.

For same hardware usage, on the receiver side, e.g., at the wireless terminal 30, the same FFT module 164 which is used for demodulating OFDMA symbols of normal duration (e.g., T_{base} duration) can be used for demodulating the duration-shortened symbols. This can be done by padding zeros outside the shortened T_{base}/N OFDM signal duration to perform detection only on the set of integer multiples of the N-th harmonic after FFT. To this end, FIG. 8 shows controller 160 as directing a “zero padding” operation for demodulating of duration-shortened symbols.

The proposed fractional frequency-time space usage can accommodate not only gaps such as transmit transition gaps (TTG) and receive transition gaps (RTG), but any non-integer-symbol-time transition gaps or the gaps between FDD frames. Non-integer-symbol-time transition gaps are those which occur if the symbol timing is not at an integer multiple of OFDM symbols, so that an extra gap is needed to push the symbol timing to be at an integer multiple of OFDM symbols. Gaps between FDD frames are, as explained earlier, occur when the frame duration is not divisible by possible values of OFDM symbol duration.

An advantage of the technology disclosed herein is that, at least in some embodiments, the same FFT circuit can be used at the transmitter, while the receiver can apply the same data demodulator and detector over a fractional symbol time window. The fractional-symbol-duration OFDM signal will have reduced peak rates and a reduced time interval to accumulate signal energy.

A set of uniformly spaced tones with fractional symbol duration can solve the problem of wasting integer number of OFDM symbols for new transition gaps in the situation of FIG. 2, as they may be too long for the transmit transition gap (TTG) and receive transition gap (RTG). In other words, if it is desired to keep the OFDM symbol timing in the UL1 period aligned with DL1 and DL2, the TTG1 gap must be an integer number of OFDM symbols, even when non-integer numbers, such as 0.3 or 1.1 OFDM symbol duration, are sufficient for the transition gap.

As shown in Table 1, in 5 MHz IEEE 802.16 systems, the OFDMA symbol duration is 102 μs, while the TTG and the RTG are 105 μs and 60 μs, respectively. Since the new downlink (DL) and uplink (UL) are inside the legacy DL subframe, the summation of TTG, RTG and the new DL/UL symbol durations must be equal to an integer multiple of OFDM symbols. If the required length of new TTG/RTG combined is not equal to an integer number of OFDM symbol, extra transmission resources (e.g., OFDM symbol) will be lost such that the combined new TTG/RTG length rounds towards the smallest integer multiple of OFDM symbol duration that is larger than that required value.

In addition, as depicted in FIG. 2, if uplink burst ULB1 is used partially for a relay station and its subordinate wireless terminal treats ULB1 as downlink, then another constraint to align ULB1 symbol timing with the legacy DL symbol timing would apply. In that scenario, without the fractional usage of an OFDM symbol, TTG1 will take at least one symbol, even if it is allowed to be less than one OFDM symbol. If the 105 μs TTG for 5 MHz is chosen, then the loss will be two OFDM symbols simply because the TTG is 3 μs longer than the 102 μs OFDM symbol. With the fractional OFDM symbol usage, if a TTG of ½ OFDM symbol is sufficient, then the remaining ½ OFDM symbol can still be used for data transmission. With the fractional usage of OFDM symbol, the starting point the new TTG1 can be pushed to a fractional OFDM symbol time after the end of DLB1, while that fractional OFDM symbol can still be used for data transmission with reduced peak rates.

Advantages of the technology disclosed herein include:
1. Reduced impact of TTG/RTG on the available time resources.
2. Capable of aligning new UL/DL symbol timing with legacy symbol timing when introducing new TTG/RTG
3. Reuse the legacy FFT structure for full OFDM symbol usage

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of operating a communications network comprising a base station and a wireless terminal which communicate a frame of information over an air interface with the base station, the method comprising:
preparing or processing the frame in a manner whereby:
(1) at least some of OFDM symbols of the frame have a symbol duration T_{base} in accordance with a base frequency 1/T_{base} of subcarriers employed for the frame;
(2) at least one duration-shortened OFDM symbol of the frame has a symbol duration T_{base}/N, wherein N is an integer greater than one and wherein a subset of subcarriers are utilized for the select OFDM symbol, the subset of subcarriers being frequencies which are integer multiples of a N^{th} harmonic of the base frequency 1/T_{base}; and
transmitting the frame over the interface.

2. The method of claim 1, further comprising inserting the duration-shortened symbol in a portion of the frame corresponding to a transition gap for at least one version of the frame.

3. The method of claim 2, further comprising inserting an integer number of the duration-shortened symbols in a portion of the frame corresponding to the transition gap.

4. The method of claim 1, wherein the frame is a time division duplex (TDD) frame or a frequency division duplex (FDD) frame.

5. A base station comprising:
a transceiver configured to communicate a frame over an air interface with a wireless terminal; and
a frame handler arranged to prepare or process the frame in a manner whereby:
(1) at least some of OFDM symbols of the frame have a symbol duration T_{base} in accordance with a base frequency 1/T_{base} of subcarriers employed for the frame;
(2) at least one duration-shortened OFDM symbol of the frame has a symbol duration T_{base}/N, wherein N is an integer greater than one and wherein a subset of subcarriers are utilized for the select OFDM symbol, the subset of subcarriers being frequencies which are integer multiples of a N^{th} harmonic of the base frequency 1/T_{base}.

6. The apparatus of claim 5, wherein the frame handler is further arranged to insert the duration-shortened symbol in a portion of the frame corresponding to a transition gap for at least one version of the frame.

7. The apparatus of claim 6, wherein the frame handler is further arranged to insert an integer number of the duration-shortened symbols in a portion of the frame corresponding to the transition gap.

8. The apparatus of claim 5, wherein the frame handler further comprises an Inverse Fast Fourier Transform (IFFT) unit or an inverse Discrete Fourier Transform (IDFT) configured to transform modulated subcarriers into a sequence of time domain samples for both the duration-shortened OFDM symbol and the symbols having symbol duration T_{base}.

9. The apparatus of claim 5, wherein the frame is a time division duplex (TDD) frame or a frequency division duplex (FDD) frame.

10. A wireless terminal comprising:
a transceiver configured to receive a frame over an air interface from a base station; and
a frame handler arranged to demodulate the frame in a manner whereby:
(1) at least some of OFDM symbols of the frame have a symbol duration T_{base} in accordance with a base frequency 1/T_{base} of subcarriers employed for the frame;
(2) at least one duration-shortened OFDM symbol of the frame has a symbol duration T_{base}/N, wherein N is an integer greater than one and wherein a subset of subcarriers are utilized for the select OFDM symbol, the subset of subcarriers being frequencies which are integer multiples of a N^{th} harmonic of the base frequency 1/T_{base}.

11. The apparatus of claim 10, wherein the frame handler is further arranged to obtain the duration-shortened symbol from a portion of the frame corresponding to a transition gap for at least one version of the frame.

12. The apparatus of claim 11, wherein the frame handler is further arranged to obtain an integer number of the duration-shortened symbols in a portion of the frame corresponding to the transition gap.

13. The apparatus of claim 10, wherein the frame is a time division duplex (TDD) frame or a frequency division duplex (FDD) frame.

14. The apparatus of claim 10, wherein the frame handler further comprises a Fast Fourier Transform (FFT) unit or a Discrete Fourier Transform unit configured to convert the time domain waveform to the frequency domain for both the duration-shortened OFDM symbol and the symbols having symbol duration T_{base}.
